(19) United States
(12) Patent Application Publication
(10) Pub. No.: US 2024/0378486 A1
(43) Pub. Date: Nov. 14, 2024

(54) EXPOSING A MACHINE LEARNING MODEL IN A NEAR REAL TIME RIC

(71) Applicant: Dell Products L.P., Round Rock, TX (US)

(72) Inventors: Omar Gad, London (GB); Marwan Mansour, Alexandria (EG); Mohamed Abouzeid, Sheikh Zayed City (EG)

(21) Appl. No.: 18/313,419

(22) Filed: May 8, 2023

(51) Int. Cl. G06N 20/00

(52) U.S. Cl. CPC G06N 20/00

(57) ABSTRACT

Architectures and techniques are described relating to implementing a serving hub within a network architecture such as a open radio access network (O-RAN). The serving hub can, inter alia, abstract a MLOps layer, serve models, and expose models for reuse. All or a portion of the serving hub can be deployed on a near real time radio access network intelligent controller (NRT RIC) with the O-RAN architecture. Hence, xApps that execute on the NRT RIC can subscribe to MLOps services without the need to implement MLOps in the xApps.

### BACKGROUND

An Open Radio Access Network (O-RAN) architecture represents a disaggregated approach to deploying mobile fronthaul and midhaul networks that can be built entirely on cloud native principles. Whereas a traditional radio access network (RAN) was proprietary, with no open interfaces and no cross-vendor interoperability, an O-RAN, can support cross-vendor interoperability as well as open application programming interfaces (APIs). Introduction of RAN intelligent controllers (RICs) to O-RAN has led to enhanced network performance as well as enabling customers to tailor network behavior to their own needs. Customization of the network can be done through xApps. In this regard, machine learning (ML) can play a role in automating and optimizing xApps.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts a schematic block diagram 100 illustrating an example 0-RAN 100 architecture in accordance with certain embodiments of this disclosure;

FIG. 2 depicts a schematic block diagram illustrating an example serving hub device 200 that can, inter alia, abstract a MLOps layer, serve models, and expose models for reuse in accordance with certain embodiments of this disclosure;

FIG. 3 depicts a schematic block diagram 300 illustrating various examples of group of APIs 218 in accordance with certain embodiments of this disclosure;

FIG. 4 illustrates block diagram 400 depicting a first example deployment scenario in which model manager 216 functionality is deployed in serving hub device 200 in accordance with certain embodiments of this disclosure;

FIG. 5 depicts block diagram 500 illustrating a second example deployment scenario in which model manager 216 functionality is split between NRT RIC 104 and SMO 102 in accordance with certain embodiments of this disclosure;

FIG. 6 depicts a first example call flow diagram 600 for the first deployment scenario in which models manager 216 is implemented in NRT RIC 104 in accordance with certain embodiments of this disclosure;

FIG. 7 depicts a second example call flow diagram 700 for the second deployment scenario in which models manager 216 is implemented in SMO 102 in accordance with certain embodiments of this disclosure;

FIG. 8A illustrates a schematic block diagram 800A relating to caching techniques for ML models 212 in accordance with certain embodiments of this disclosure;

FIG. 8B illustrates a schematic block diagram 800B relating to user-friendly techniques for searching for exiting ML models 212 in accordance with certain embodiments of this disclosure;

FIG. 9 depicts a schematic diagram illustrating an example network architecture 900 that can enable both local or global model training and/or model sharing in accordance with certain embodiments of this disclosure;

FIG. 10 illustrates an example method relating to a serving hub that can abstract a MLOps layer, serve models, and expose models for reuse in accordance with certain embodiments of this disclosure;

FIG. 11 illustrates an example method that can provide for additional aspect or elements in connection with the serving hub in accordance with certain embodiments of this disclosure;

FIG. 12 illustrates a block diagram of an example distributed file storage system that employs tiered cloud storage in accordance with certain embodiments of this disclosure; and

FIG. 13 illustrates an example block diagram of a computer operable to execute certain embodiments of this disclosure.

### DETAILED DESCRIPTION

### Overview

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

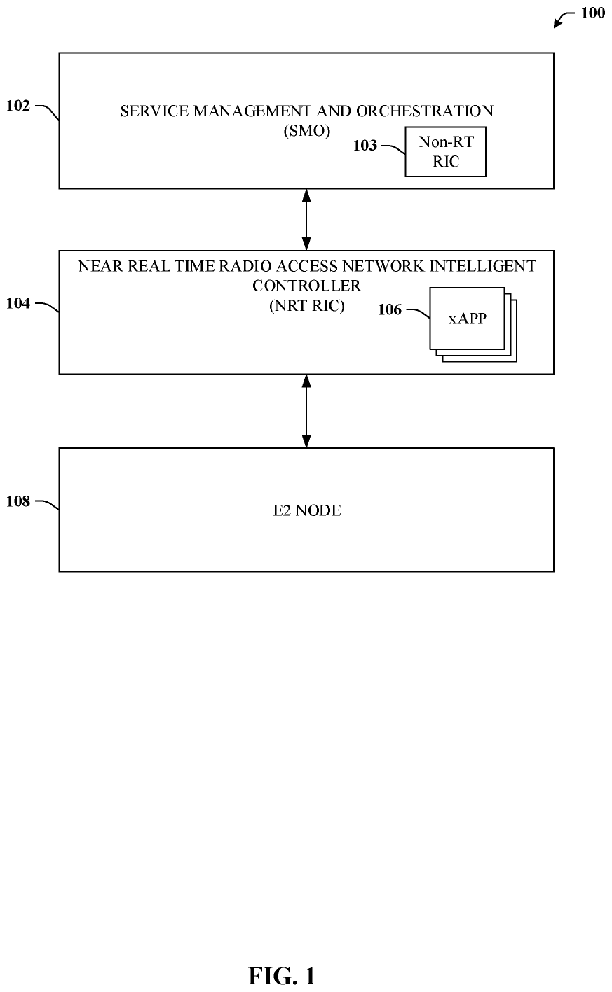

In order to better describe the disclosed subject matter, it can be instructive to consider relevant aspects of an O-RAN architecture. FIG. 1 depicts a schematic block diagram 100 illustrating an example O-RAN 100 architecture in accordance with certain embodiments of this disclosure. O-RAN 100 can comprise service management and orchestration (SMO) 102, which can be implemented in a network core.

As was noted, O-RAN specifications introduced RICs, e.g., to improve performance and enable customization. As one example, a non-real time (RT) RIC 103 can be deployed in SMO 102. Since non-RT RIC 103 typically resides in the core and/or at a location with significant available resources, non-RT RIC 103 may have significant processing capability, which can be leveraged via rApps (not shown). However, due to network topology, SMO 102 may be distant from a network edge and therefore incur significant latency penalties. As such, non-RT RIC 103 is intended to handle non-real time events or operations such as those that are greater than one second.

In contrast, typically deployed at or near a network edge can be near-RT (NRT) RIC 104. NRT RIC 104, due to its proximity to a network edge, can handle so-called near real time events or operations such as, e.g., those between 10 milliseconds and one second. In this regard, a non-RT RIC and a near-RT RIC are configured to handle different speeds of operations or events, with the non-RT RIC handling a first range of speeds of operations or events, the near-RT RIC handling a second range of speeds of operations or events faster than the first range. It is appreciated that various other splits are possible and may change with changing specifications without departing from techniques detailed in this disclosure.

As was described, NRT RIC 104 can be customized using one or more xApps 106 and such customization is increasingly relying on artificial intelligence and/or ML. For example, a given xApp 106 can consume network data or metrics (e.g., key performance indicators (KPIs)) and, based on that network data and potentially control of some network metric, perform a function. As one example, this function may relate to a prediction such as a QoS prediction, a traffic prediction, an anomaly detection prediction or the like. Appreciably, such can be used for improving network health, improving network performance, or any other suitable result. Decisions or other output from xApps 106 can be provided to E2 node 108.

In existing approaches, the ML models are coded as part of xApps 106. Thus, significant reliance on ML models for xApps 106, leads to numerous challenges, both in the context of implementation and efficiency as well as in the context of authentication.

For example, in the context of implementation and efficiency, according to current approaches, each xApp 106 essentially develops its own model from scratch in order to optimize or customize a specific network function. Such is inefficient and potentially redundant since a similar use case may exist for the developed model. In previous approaches, there is no standard process for model serving for xApps, which can lead to unnecessary implementation overhead of model serving processes. In previous approaches, creating an automated ML operations (MLOps) pipeline to automate the process of training and serving a given model is at least partially the responsibility of the xApp 106 developer, who typically do not have expertise in ML domains. It is further observed that the overhead of developing ML models in xApp 106 requires additional resources on NRT RIC, which is significantly more expensive relative to SMO 102 resources, particularly for large scale deployments. Moreover, long model development life cycle, e.g., including training, testing, and serving models, illustrates that reusing already trained models can be advantageous.

In the context of authentication challenges, it is noted that not all xApps 106 have access to the same data sources, which is currently controlled by authentication elements. This can be due to a variety of different reasons such as due to laws and restrictions, which can be jurisdictional, based on permissions of an operator or carrier, based on logic of a particular implementation taking computation into consideration, or the like. Furthermore, in some cases, narrow exposure to diverse training data may exist due, e.g., to training data being limited as a result of a limited number of exposed E2 nodes.

The disclosed subject matter can in various embodiments mitigate or overcome the aforementioned challenges, by, for example, abstracting an MLOps layer, automatically serving models and exposing models for reuse within the same NRT RIC 104 or other NRT RICs 104 instances within a network based on the use case for any xApp 106 with the authorization to use the model. For example, rather than deploying ML models with the xApps 106 themselves, as was conventionally done, ML models can be disaggregated from the xApps 106. In that regard, the disclosed techniques relate to a serving hub that is introduced to O-RAN architecture. The serving hub can be adapted as a centralized hub for accessing and sharing trained ML models (or any other suitable type of model). The serving hub can expose these models to be used by different applications (e.g., xApps 106) for inferencing. The serving hub concept can enable authorized users to reuse shared models for prediction without the hassle of identifying and preparing associated data, training the model, or exposing the model to be used for inferencing. In some embodiments, the serving hub can serve models globally to be used as an independent service by an application without the need to handle the training for models that are publicly exposed. In some embodiments, the serving hub can enable searching for all available models. For example, the best matching model for a given user's needs can be identified and the model's API documentation can be provided. Further, in some embodiments, the serving hub can improve the footprint of the models running on top of the RIC by, e.g., optimizing the cached models. Additional detail relating to the serving hub or other elements is further described herein.

### Example Systems

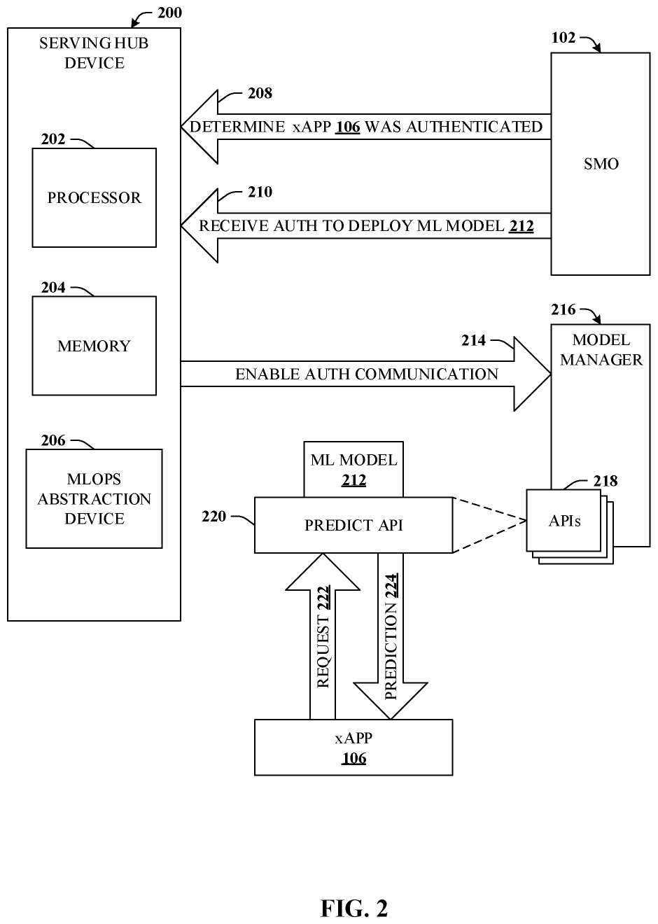

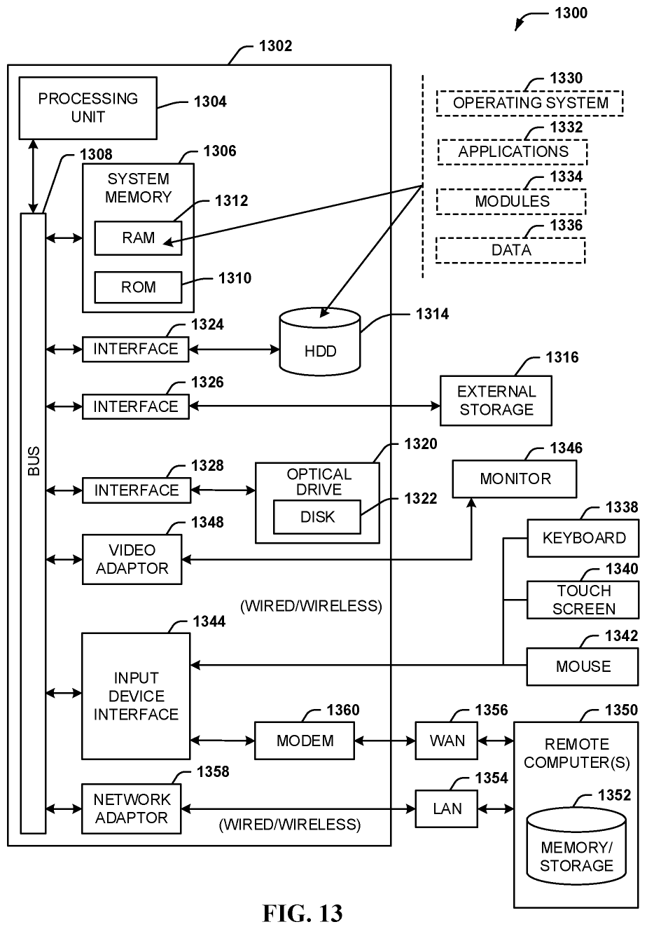

Referring now to FIG. 2, a schematic block diagram is depicted illustrating an example serving hub device 200 that can, inter alia, abstract a MLOps layer, serve models, and expose models for reuse in accordance with certain embodiments of this disclosure. Serving hub device 200 can comprise a processor 202 that can be specifically configured to perform function associated with assigning, updating, or migrating permissions. Serving hub device 200 can also comprise memory 204 that stores executable instructions that, when executed by processor 202, can facilitate performance of operations. Processor 202 can be a hardware processor having structural elements known to exist in connection with processing units or circuits, with various operations of processor 202 being represented by functional elements shown in the drawings herein that can require special-purpose instructions, for example, stored in memory 204 and/or MLOps abstraction device 206. Along with these special-purpose instructions, processor 202 and/or MLOps abstraction device 206 can be a special-purpose device. Further examples of the memory 204 and processor 202 can be found with reference to FIG. 13. It is to be appreciated that processor 202 or computer 1302 can represent a server device or a client device of a network or network services platform and can be used in connection with implementing one or more of the systems, devices, or components shown and described in connection with FIG. 2 and other figures disclosed herein.

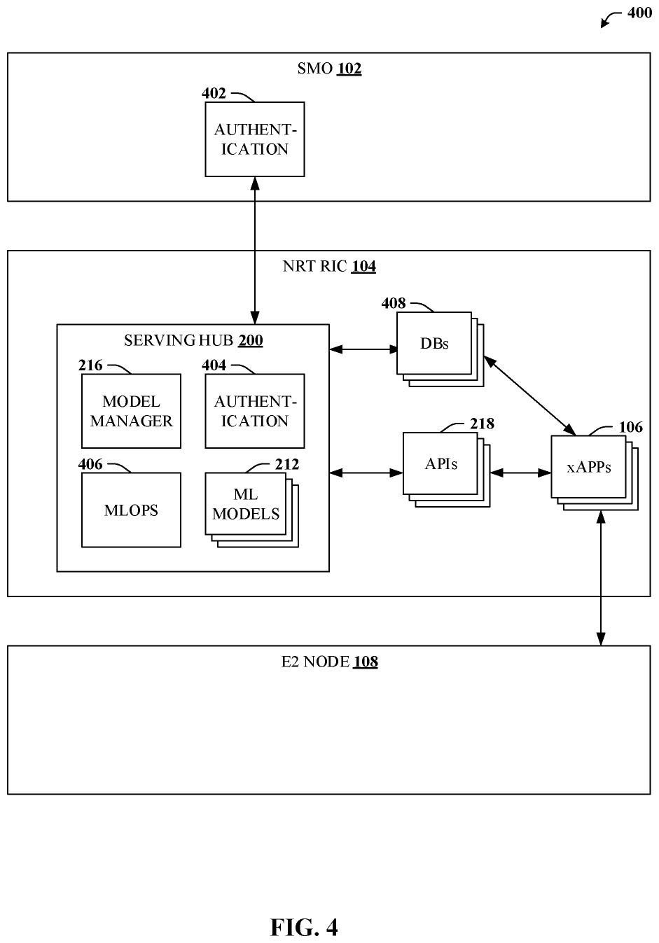

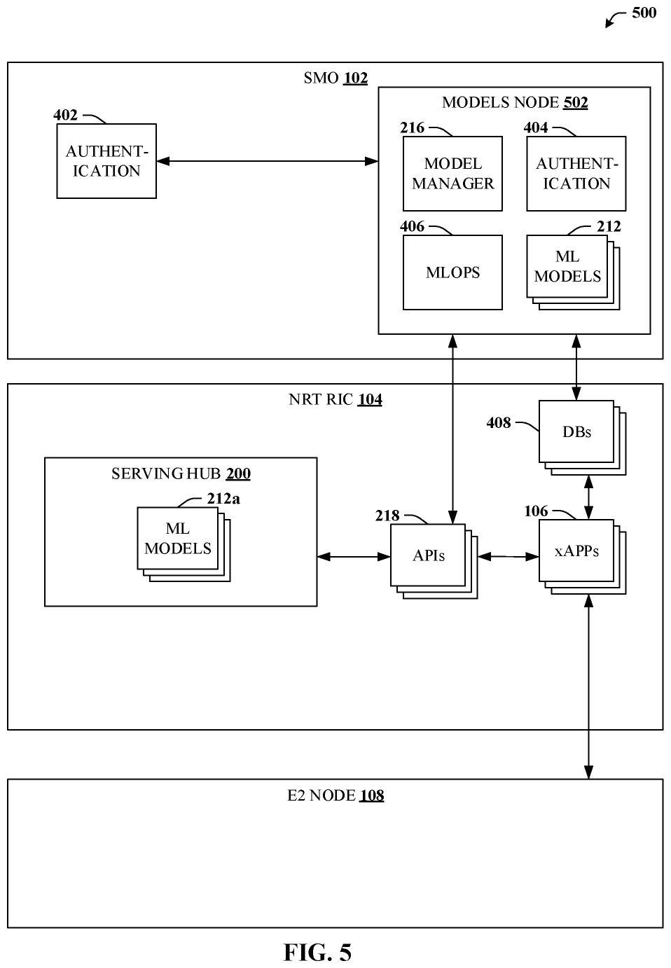

Initially, it is understood that all or portions of serving hub device 200 can be situated in NRT RIC 104. However, depending on implementation, various other elements (e.g., model manager 216, detailed below) can be deployed in either NRT RIC 104 in a first deployment scenario (e.g., see FIG. 4) or in SMO 102 in a second deployment scenario (e.g., see FIG. 5). In some embodiments, serving hub device 200 can abstract MLOps into a serving entity that exposes trained ML models 212 to various xApps 106. Hence, developers of xApps 106 need not have any experience with ML models 212 or other associated model types to leverage the provided predictions or other output. Furthermore, xApps 106 that call ML models 212 as a service do not need to have access to the data that was used to train the ML models 212. Rather, the xApp 106 need only be authenticated to call a particular ML model 212. For all or a portion of the transactions detailed herein, authentication can be handled by an authentication layer. Details of the authentication layer may change based on the deployment scenario, which is further detailed below.

At reference numeral 208, serving hub device 200 can determine that xApp 106 was authenticated for deployment on an associated NRT RIC 104. Authentication can be performed as a function between SMO 102 and NRT RIC 104. At reference numeral 210, authentication is received by serving hub device 200 to deploy ML model 212 on NRT RIC 104. Authentication can be received from SMO 102.

At reference numeral 214, serving hub device 200 can enable authenticated communication for model manager 216. Model manager 216 can manage ML model(s) 212 via a group of application programming interfaces (APIs) 218. Depending on the deployment scenario, all or some subset of the group of APIs 218 can be exposed by serving hub device 200 on NRT RIC 104. For instance, as a potential minimum subset, predict API 220 can be exposed by serving hub device 200. As illustrated, predict API 220 allows xApp 106 to make a call to predict API 220, e.g., via request 222 and, in response, receive prediction 224 as output from ML model 212 in order to satisfy request 222.

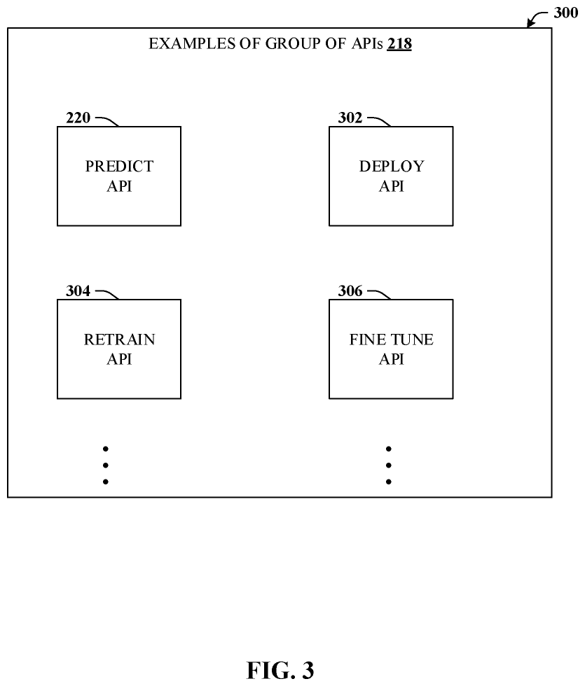

Turning now to FIG. 3, a schematic block diagram 300 is depicted illustrating various examples of group of APIs 218 in accordance with certain embodiments of this disclosure. Group of APIs 218 are intended to represent various ways in which xApp 106 can interact with ML model 212, potentially independent of where ML model 212 resides and/or where ML model 212 is exposed. As has already been introduced, group of APIs 218 can include predict API 220. Predict API 220 can provide ML model predictions (e.g., prediction 224) based on ML model input (e.g., request 222) provided by xApp 106. Predict API 220 can be exposed by serving hub device 200 of NRT RIC 104.

Group of APIs 218 can further include deploy API 302. Deploy API 302 can allow an operator to deploy ML model 212 to serving hub device 200 to be used by xApps 106. The ML model 212 that is deployed can be pre-trained by model manager 216. Deploy API 302 can be exposed by serving hub device 200 in the NRT RIC 104 in one deployment scenario or exposed by the model manager 216 in SMO 102 in another deployment scenario.

Group of APIs 218 can also include re-train API 304. Re-train API 304 can allow xApps 106 to trigger model retraining on a new or different dataset. A call to re-train API 304 can receive the training dataset upon which to re-train ML model 212 and, subsequently call deploy API 302 to deploy the newly trained ML model. Re-train API 304 can be exposed by serving hub device 200 in the NRT RIC 104 in one deployment scenario or exposed by the model manager 216 in SMO 102 in another deployment scenario.

Group of APIs 218 can further include fine tune API 306. Fine tune API 306 can allow xApps 106 to trigger a fine tuning operation that, e.g., utilizes pre-trained model weights, but fine tunes the model using updated data. A call to fine tune API 306 can receive the training dataset upon which to fine tune ML model 212 and, subsequently call deploy API 302 to deploy the tuned ML model. Fine tune API 306 can be exposed by serving hub device 200 in the NRT RIC 104 in one deployment scenario or exposed by the model manager 216 in SMO 102 in another deployment scenario.

With reference now to FIG. 4, block diagram 400 is presented. Block diagram 400 depicts a first example deployment scenario in which model manager 216 functionality is deployed in serving hub device 200 in accordance with certain embodiments of this disclosure. As previously detailed, an authentication layer 402 can ensure that only authorized requests with respect to ML models 212 are allowed. However, in this embodiment, authentication can be exposed in serving hub device 200 via authentication 404. Likewise, as previously noted, serving hub device 200 can operate to abstract MLOps 406 by exposing ML models 212. In this scenario, model manager 216 is deployed in serving hub device 200 as shown or, alternatively, can otherwise be deployed on NRT RIC 104. Models manager 216 can control deployment, training, and other management of ML models 212.

In this scenario, all of the group of APIs 218 are exposed by serving hub device 200. Hence, resources of NRT RIC 104 are utilized for all API calls from xApps 106 or from other sources. Databases 408 can represent data that is local to NRT RIC 104 and may be used for re-training or fine tuning ML models 212. Such an implementation has the advantage of significantly faster response times. However, this implementation also increases the footprint of serving hub device 200 on the NRT RIC 104, where resources are generally less abundant and more expensive than for SMO 102.

Now referring to FIG. 5, block diagram 500 is presented. Block diagram 500 depicts a second example deployment scenario in which model manager 216 functionality is split between NRT RIC 104 and SMO 102 in accordance with certain embodiments of this disclosure. In this scenario, models node 502 is implemented in SMO 102. Models node 502 can incorporate all or a portion of functionality that was deployed in serving hub device 200. For example, model manager 216, authentication 404, some abstraction of MLOps 406, and ML models 212 can reside and/or be exposed in SMO 102 rather than, or in addition to, serving hub device 200 of NRT RIC 104.

It is appreciated that pre-training or re-training ML models 212 is generally more resource-intensive than executing those modes to generate results. Thus, predict API 220 may be exposed on serving hub device 200 residing at NRT RIC 104, whereas re-train API 304 or fine tune API 306 can be exposed by models node 502 residing at SMO 102.

In particular, this deployment scenario can serve to disaggregate the prediction functionality from the training functionality. Such can decrease the footprint of serving hub device 200 on NRT RIC 104, allowing better performance for low latency use cases, while relying on the more abundant resources of SMO 102 to perform more resource-intensive tasks that generally are constrained by latency demands. In some embodiments, this second deployment scenario exposes all of the group of APIs 218 on SMO 102 with the exception of predict API 220, which remains exposed on serving hub device 200 of NRT RIC 104. Thus, models node 502 can handle deployment of ML models 212 as well as pre-training, re-training, or fine tuning of ML models 212. Serving hub device 200 can store all or a portion of ML models 212, which is labeled here as ML models 212a.

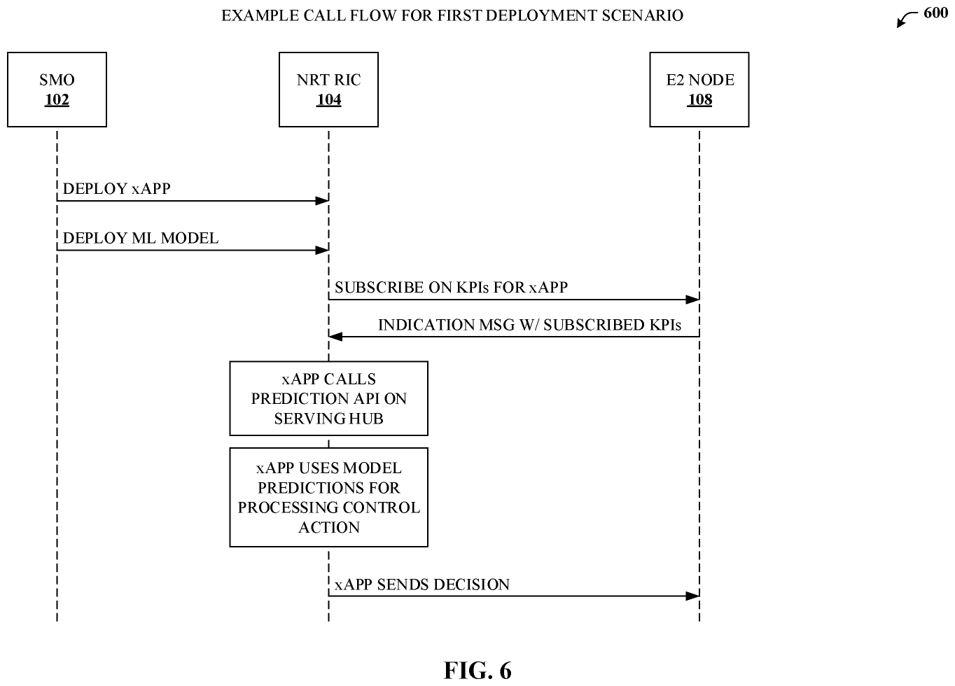

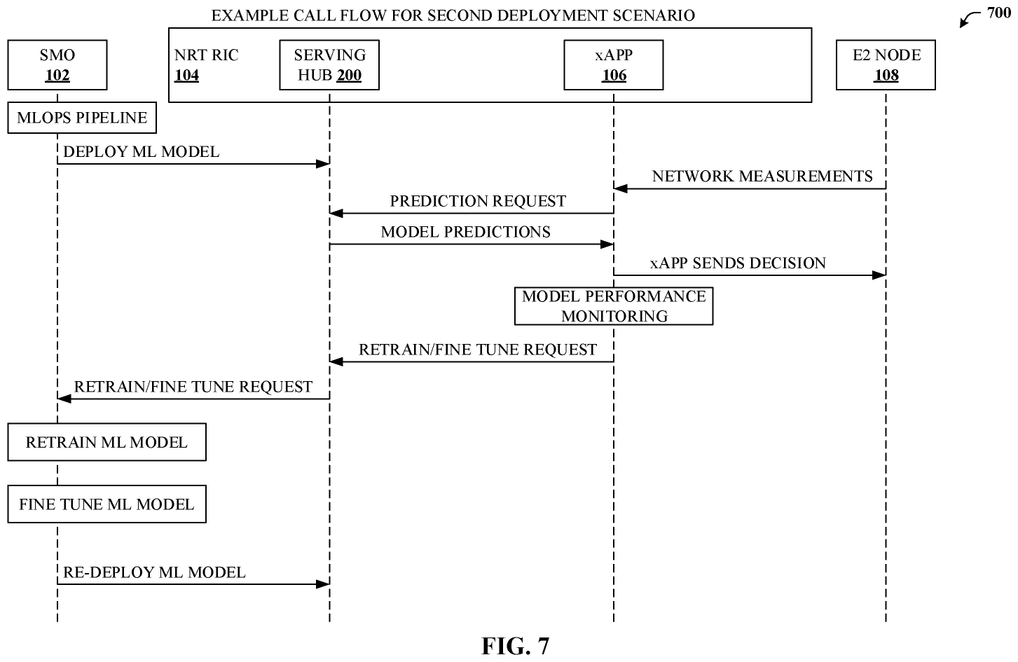

FIG. 6 depicts a first example call flow diagram 600 for the first deployment scenario in which model manager 216 is implemented in NRT RIC 104 in accordance with certain embodiments of this disclosure. FIG. 7 depicts a second example call flow diagram 700 for the second deployment scenario in which model manager 216 is implemented in SMO 102 in accordance with certain embodiments of this disclosure.

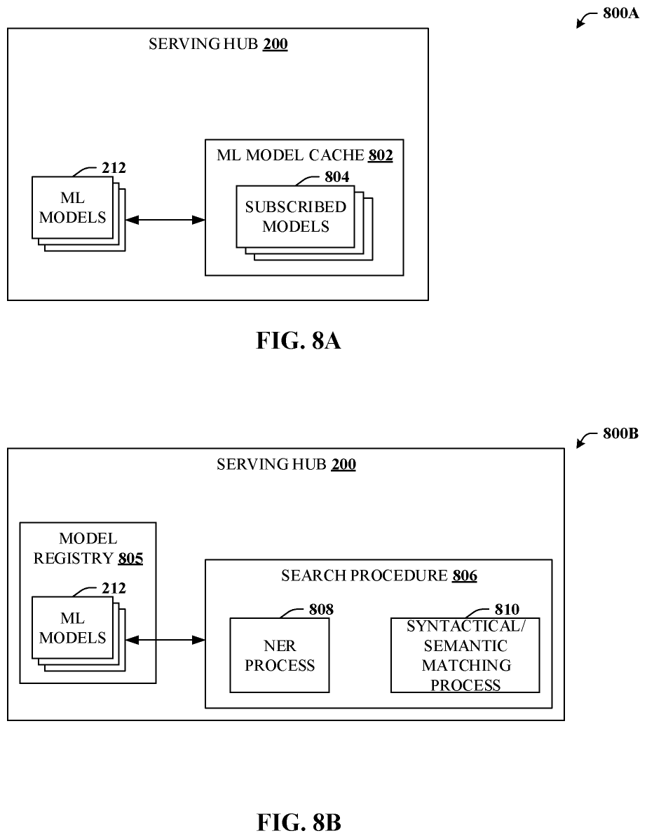

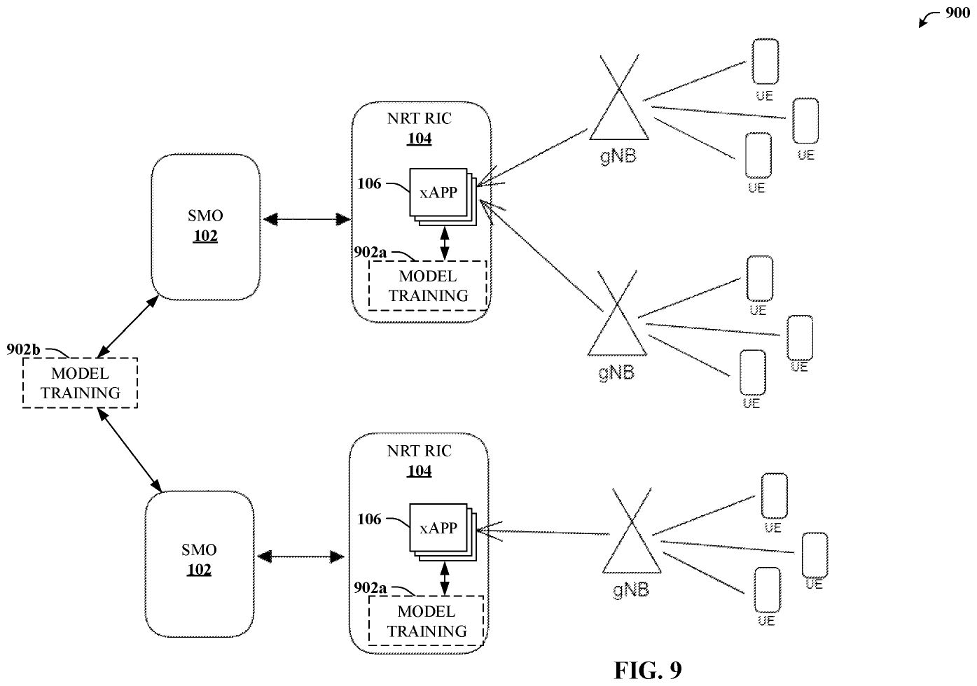

Turning now to FIGS. 8A, 8B, and 9, additional aspects or elements of serving hub 200 are detailed. For example, FIG. 8A illustrates a schematic block diagram 800A relating to caching techniques for ML models 212 in accordance with certain embodiments of this disclosure. For example, deployed models (e.g., ML models 212) can be serialized and stored on NRT RIC 104, and specifically, as shown here on serving hub device 200. In some embodiments, serialized models can be stored in a file system and loaded by serving hub device 200 for inference requests. In other embodiments, serialized models can be stored in a database for faster access. Of all deployed models 212, a subset, referred to here as subscribed models 804 can be cached and stored in ML model cache 802 for more rapid access to the requested inferences. As one example, ML model cache 802 can be embodied as high-speed memory.

With an increase in the number of deployed models, challenges arise in maintaining availability of the actively used models and serving the associated requests in a timely manner. Hence, membership in ML cache 802 can be a function of active use or requests by xApps 106. In some embodiments, membership in ML cache 802 can be based on certain criteria or a criterion, which can be a membership criterion or an eviction criterion. For example, the criterion can be a function of at least one of a low latency constraint associated with xApp 106, a recency of use, a frequency of use, a subscription flow to a given ML model 212, or another suitable criterion.

FIG. 8B illustrates a schematic block diagram 800B relating to user-friendly techniques for searching for existing ML models 212 in accordance with certain embodiments of this disclosure. Again, with an increase in the number of deployed models, challenges may arise for xApp 106 developers to identify the available ML models 212 that may suit their own needs and/or identify the most suitable ML model for a given use-case. In some cases, technical expertise might be required to identify the appropriate model from a vast model catalogue.

To meet these challenges, model search procedures 806 can be implemented along with a model registry 805. Model search procedures 806 can in some instances automate the identification of the most relevant ML model 212 for a given use-case based on queries defined by an operator, carrier, or another suitable entity.

In some embodiments, model registry 805 can maintain a metadata structure associated with the available ML models 212. As one example, SMO 102 can send a search request, including a given query to model registry 805. Model registry can identify the most relevant model to the search query based on one description(s) stored in the metadata. In some embodiments, the matched models' documentation can be returned to the requestor.

In some embodiments, a description of a given ML model 212 can be added as the underlying ML model 212 is deployed from SMO 212. Model tags can be entered as keywords depending on the application of ML model 212. In some embodiments, model search queries can be entered in a natural language format. For instance, keywords entered as a search query can be used for model searching. In some embodiments, named entity recognition (NER) 808 can be used to identify keywords in model descriptions and store those keywords to a suitable data store. In some embodiments, the model search queries can be matched to the most relevant available models using syntactical and/or semantic matching techniques 810.

With specific reference to FIG. 9, an example network architecture 900 is illustrated that can enable both local or global model training and/or model sharing in accordance with certain embodiments of this disclosure. Generally, SMO 102 can be communicatively coupled to one or more NRT RIC 104, where xApps 106 reside. Each NRT RIC 104 can be communicatively coupled to one or more NodeB device such as a next generation nodeB or gNB. As illustrated, each gNB can provide service to multiple UE.

It is appreciated that large operators or carriers can manage or maintain many different SMOs 102 and these different SMOs 102 can cover a large geographic area, even span multiple different countries or other jurisdictions. In some cases, data collected at one NRT RIC 104 (e.g., directed to customer traffic patterns, usage metrics and so forth) may be quite different from similar data collected at a different NRT RIC 104. In some cases, this situation may be preferred to locally train ML model 212 that is making prediction for that segment of the network. However, in other cases, having a more diverse set of data to train ML model 212 can be advantageous depending on the use-case of the ML model 212.

Hence, the disclosed techniques can have the capability to perform model training using local data, as illustrated at reference numeral 902a or using global data as illustrated at reference numeral 902b. Similarly, model sharing can be facilitated based on local or global principles.

### Example Methods

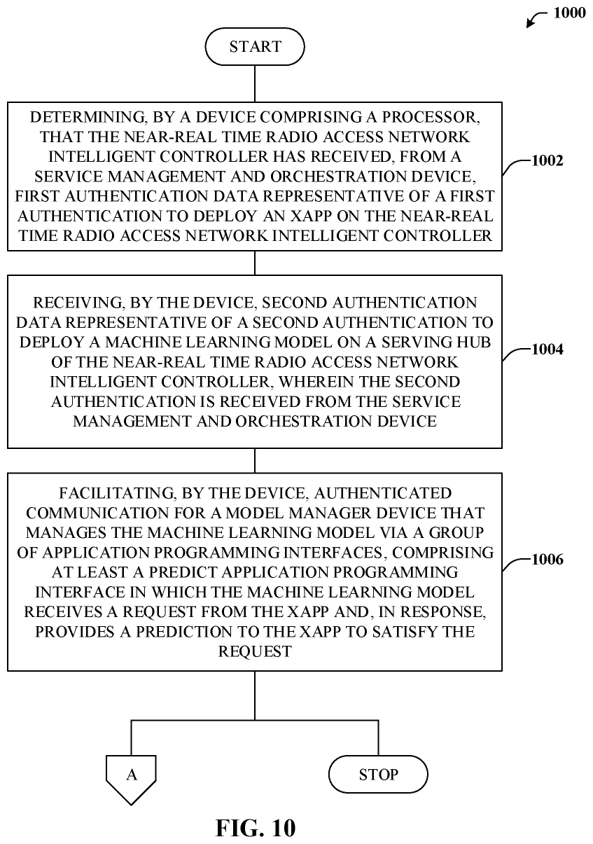

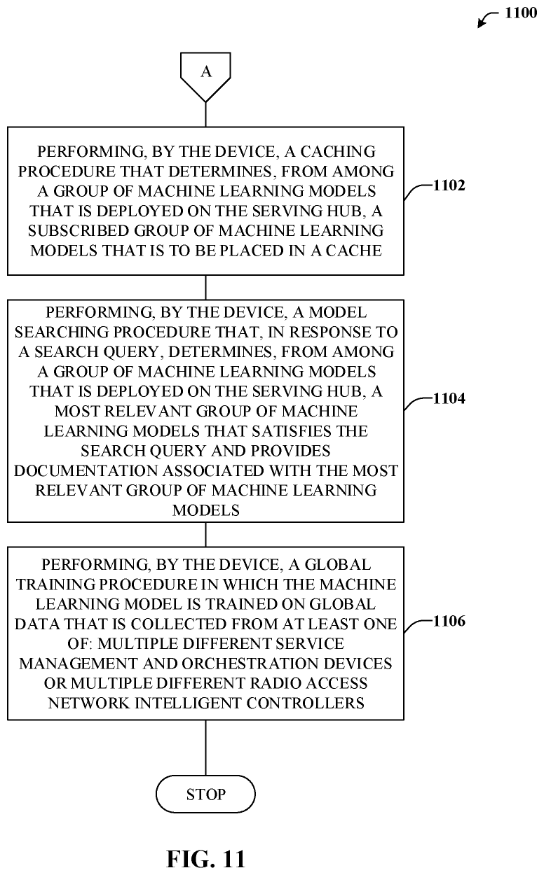

FIGS. 10 and 11 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Referring now to FIG. 10, exemplary method 1000 is depicted. Method 1000 relates to a serving hub that can abstract a MLOps layer, serve models, and expose models for reuse in accordance with certain embodiments of this disclosure. While method 1000 describes a complete method, in some embodiments, method 1000 can include one or more elements of method 1100, as illustrated by insert A.

At reference numeral 1002, a device comprising a processor can receive first authentication data representative of a first authentication to deploy an xApp on a near-real time radio access network intelligent controller. The first authentication can be received from a service management and orchestration device. In other words, deployment of the xApp can be subject to an authentication layer or the service management and orchestration device.

At reference numeral 1004, the device can receive second authentication data representative of a second authentication to deploy a machine learning model on a serving hub of the near-real time radio access network intelligent controller. The second authentication can be received from the service management and orchestration device. Hence, deployment of the machine learning model can be subject to an authentication layer or the service management and orchestration device.

At reference numeral 1006, the device can facilitate authenticated communication for a model manager device that manages the machine learning model via a group of application programming interfaces. This group of application programming interfaces can comprise at least a predict application programming interface. The prediction application programming interface can serve requests to the machine learning model. For example, the machine learning model can, via the predict application programming interface, receives a request from the xApp and, in response, provides a prediction to the xApp to satisfy the request. Method 1000 can terminate or continue to insert A, which is further detailed in connection with FIG. 11.

Turning now to FIG. 11, exemplary method 1100 is depicted. Method 1100 can provide for additional aspect or elements in connection with the serving hub in accordance with certain embodiments of this disclosure.

At reference numeral 1102, the device introduced at reference numeral 1002 comprising a processor can perform a caching procedure. The caching procedure can determine, from among a group of machine learning models that is deployed on the serving hub, a subscribed group of machine learning models that is to be placed in a cache.

At reference numeral 1104, the device can perform a model searching procedure. The model searching procedure can, in response to a search query, determine, from among a group of machine learning models that is deployed on the serving hub, a most relevant machine learning model or a most relevant group of machine learning models that satisfies the search query. Further in response to determining the most relevant group of machine learning models, documentation associated with the most relevant group of machine learning models can be provided.

At reference numeral 1106, the device can perform a global training procedure. The global training procedure can facilitate the machine learning model being trained on global data that is collected from at least one of: multiple different service management and orchestration devices or multiple different radio access network intelligent controllers.

### Example Operating Environments

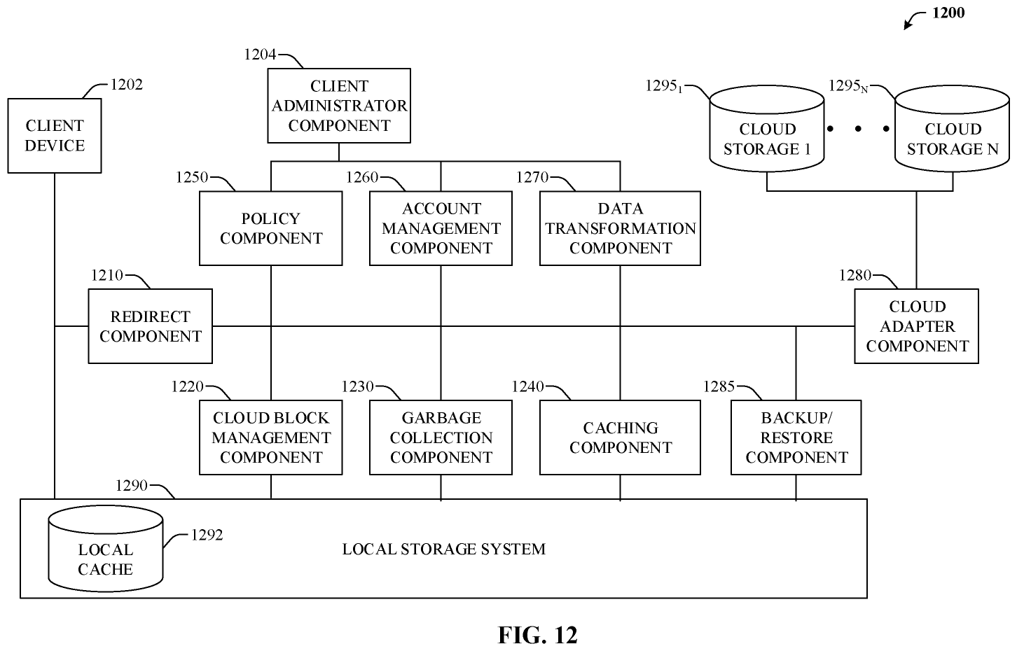

To provide further context for various aspects of the subject specification, FIGS. 12 and 13 illustrate, respectively, a block diagram of an example distributed file storage system 1200 that employs tiered cloud storage and block diagram of a computer 1302 operable to execute the disclosed storage architecture in accordance with aspects described herein.

Referring now to FIG. 12, there is illustrated an example local storage system including cloud tiering components and a cloud storage location in accordance with implementations of this disclosure. Client device 1202 can access local storage system 1290. Local storage system 1290 can be a node and cluster storage system such as an EMC Isilon Cluster that operates under OneFS operating system. Local storage system 1290 can also store the local cache 1292 for access by other components. It can be appreciated that the systems and methods described herein can run in tandem with other local storage systems as well.

As more fully described below with respect to redirect component 1210, redirect component 1210 can intercept operations directed to stub files. Cloud block management component 1220, garbage collection component 1230, and caching component 1240 may also be in communication with local storage system 1290 directly as depicted in FIG. 12 or through redirect component 1210. A client administrator component 1204 may use an interface to access the policy component 1250 and the account management component 1260 for operations as more fully described below with respect to these components. Data transformation component 1270 can operate to provide encryption and compression to files tiered to cloud storage. Cloud adapter component 1280 can be in communication with cloud storage 1 1295₁ and cloud storage N 1295_{N}, where N is a positive integer. It can be appreciated that multiple cloud storage locations can be used for storage including multiple accounts within a single cloud storage location as more fully described in implementations of this disclosure. Further, a backup/restore component 1285 can be utilized to back up the files stored within the local storage system 1290.

Cloud block management component 1220 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 1220 in chunks of data. A uniform chunk size can be selected where all files that tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 1260 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 1220 based on list of mappings it manages. For example, each stub can be associated with an account, and the cloud block management component 1220 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 1280 manages the sending and receiving of data to and from the cloud service providers. The cloud adapter component 1280 can utilize a set of APIs. For example, each cloud service provider may have provider specific API to interact with the provider.

A policy component 1250 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 1230. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 1230 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 1240 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 1220, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 1240 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 1240 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that it has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time it is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 1270 can encrypt and/or compress data that is tiered to cloud storage. In relation to encryption, it can be appreciated that when data is stored in off-premises cloud storage and/or public cloud storage, users can require data encryption to ensure data is not disclosed to an illegitimate third party. In one implementation, data can be encrypted locally before storing/writing the data to cloud storage.

In one implementation, the backup/restore component 1285 can transfer a copy of the files within the local storage system 1290 to another cluster (e.g., target cluster). Further, the backup/restore component 1285 can manage synchronization between the local storage system 1290 and the other cluster, such that, the other cluster is timely updated with new and/or modified content within the local storage system 1290.

In order to provide additional context for various embodiments described herein, FIG. 13 and the following discussion are intended to provide a brief, general description of a suitable computing environment 1300 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 13, the example environment 1300 for implementing various embodiments of the aspects described herein includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 includes ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also include a high-speed RAM such as static RAM for caching data.

The computer 1302 further includes an internal hard disk drive (HDD) 1314 (e.g., EIDE, SATA), one or more external storage devices 1316 (e.g., a magnetic floppy disk drive (FDD) 1316, a memory stick or flash drive reader, a memory card reader, etc.) and an optical disk drive 1320 (e.g., which can read or write from a CD-ROM disc, a DVD, a BD, etc.). While the internal HDD 1314 is illustrated as located within the computer 1302, the internal HDD 1314 can also be configured for external use in a suitable chassis (not shown). Additionally, while not shown in environment 1300, a solid state drive (SSD) could be used in addition to, or in place of, an HDD 1314. The HDD 1314, external storage device(s) 1316 and optical disk drive 1320 can be connected to the system bus 1308 by an HDD interface 1324, an external storage interface 1326 and an optical drive interface 1328, respectively. The interface 1324 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

Computer 1302 can optionally comprise emulation technologies. For example, a hypervisor (not shown) or other intermediary can emulate a hardware environment for operating system 1330, and the emulated hardware can optionally be different from the hardware illustrated in FIG. 13. In such an embodiment, operating system 1330 can comprise one virtual machine (VM) of multiple VMs hosted at computer 1302. Furthermore, operating system 1330 can provide runtime environments, such as the Java runtime environment or the .NET framework, for applications 1332. Runtime environments are consistent execution environments that allow applications 1332 to run on any operating system that includes the runtime environment. Similarly, operating system 1330 can support containers, and applications 1332 can be in the form of containers, which are lightweight, standalone, executable packages of software that include, e.g., code, runtime, system tools, system libraries and settings for an application.

Further, computer 1302 can be enable with a security module, such as a trusted processing module (TPM). For instance with a TPM, boot components hash next in time boot components, and wait for a match of results to secured values, before loading a next boot component. This process can take place at any layer in the code execution stack of computer 1302, e.g., applied at the application execution level or at the operating system (OS) kernel level, thereby enabling security at any level of code execution.

A user can enter commands and information into the computer 1302 through one or more wired/wireless input devices, e.g., a keyboard 1338, a touch screen 1340, and a pointing device, such as a mouse 1342. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1304 through an input device interface 1344 that can be coupled to the system bus 1308, but can be connected by other interfaces, such as a parallel port, an IEEE 1394 serial port, a game port, a USB port, an IR interface, a BLUETOOTH® interface, etc.

A monitor 1346 or other type of display device can be also connected to the system bus 1308 via an interface, such as a video adapter 1348. In addition to the monitor 1346, a computer typically includes other peripheral output devices (not shown), such as speakers, printers, etc.

The computer 1302 can operate in a networked environment using logical connections via wired and/or wireless communications to one or more remote computers, such as a remote computer(s) 1350. The remote computer(s) 1350 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1352 is illustrated. The logical connections depicted include wired/wireless connectivity to a local area network (LAN) 1354 and/or larger networks, e.g., a wide area network (WAN) 1356. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the local network 1354 through a wired and/or wireless communication network interface or adapter 1358. The adapter 1358 can facilitate wired or wireless communication to the LAN 1354, which can also include a wireless access point (AP) disposed thereon for communicating with the adapter 1358 in a wireless mode.

When used in a WAN networking environment, the computer 1302 can include a modem 1360 or can be connected to a communications server on the WAN 1356 via other means for establishing communications over the WAN 1356, such as by way of the Internet. The modem 1360, which can be internal or external and a wired or wireless device, can be connected to the system bus 1308 via the input device interface 1344. In a networked environment, program modules depicted relative to the computer 1302 or portions thereof, can be stored in the remote memory/storage device 1352. It will be appreciated that the network connections shown are example and other means of establishing a communications link between the computers can be used.

When used in either a LAN or WAN networking environment, the computer 1302 can access cloud storage systems or other network-based storage systems in addition to, or in place of, external storage devices 1316 as described above. Generally, a connection between the computer 1302 and a cloud storage system can be established over a LAN 1354 or WAN 1356 e.g., by the adapter 1358 or modem 1360, respectively. Upon connecting the computer 1302 to an associated cloud storage system, the external storage interface 1326 can, with the aid of the adapter 1358 and/or modem 1360, manage storage provided by the cloud storage system as it would other types of external storage. For instance, the external storage interface 1326 can be configured to provide access to cloud storage sources as if those sources were physically connected to the computer 1302.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 1302.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 5 GHz radio band at a 54 Mbps (802.11a) data rate, and/or a 2.4 GHz radio band at an 13 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A serving hub device, comprising:
a processor that processes data for a near real time radio access network intelligent controller; and
a memory that stores executable instructions that, when executed by the processor, facilitate performance of operations, comprising:
determining that the near-real time radio access network intelligent controller has received, from a service management and orchestration device, first authentication data representative of a first authentication to deploy an xApp on the near-real time radio access network intelligent controller;
receiving, from the service management and orchestration device, second authentication data representative of a second authentication to deploy a machine learning model on the serving hub device; and
enabling authenticated communication for a model manager device that manages the machine learning model via a group of application programming interfaces, comprising at least a predict application programming interface in which the machine learning model receives a request from the xApp and, in response, provides a prediction to the xApp to satisfy the request.

2. The serving hub device of claim 1, wherein the group of application programming interfaces further comprises at least one of:
a deploy application programming interface that enables authenticated deployment, to the serving hub device, of the machine learning model that was pre-trained by the model manager device according to a first dataset;
a retrain application programming interface that retrains all model weights of the machine learning model based on a received second dataset, resulting in a retrained machine learning model, and calls the deploy application programming interface to deploy the retrained machine learning model on the serving hub device; or
a fine tune application that adjusts at least one model weight of the machine learning model based on a received third dataset, resulting in a tuned machine learning model, and calls the deploy application programming interface to deploy the tuned machine learning model on the serving hub device.

3. The serving hub device of claim 1, wherein the model manager device is situated in the near real time radio access network intelligent controller and uses resources of the near real time radio access network intelligent controller to process all calls to the group of application programming interfaces.

4. The serving hub device of claim 1, wherein the model manager device is situated in the service management and orchestration device and uses resources of the service management and orchestration device to process specified calls to the group of application programming interfaces, while exposing the predict application programming interface in the serving hub device.

5. The serving hub device of claim 1, wherein the operations further comprise performing a caching procedure that determines, from among a group of machine learning models that is deployed on the serving hub device, a subscribed group of machine learning models that is to be placed in a cache.

6. The serving hub device of claim 5, wherein the caching procedure determines the subscribed group as a function of at least one of: a first criterion, satisfaction of which is indicative of a low latency constraint associated with the xApp, a second criterion, satisfaction of which is indicative of a recency of use, a third criterion, satisfaction of which is indicative of a frequency of use, or a fourth criterion, satisfaction of which is indicative of a subscription flow to a given machine learning model of the group of machine learning models.

7. The serving hub device of claim 1, wherein the operations further comprise performing a model searching procedure that, in response to a search query, determines, from among a group of machine learning models that is deployed on the serving hub device, a most relevant group of machine learning models that satisfies the search query and communicates documentation associated with the most relevant group of machine learning models.

8. The serving hub device of claim 7, wherein the model searching procedure is configured to interpret a natural language search query by matching search keywords to model keywords entered as metadata model tags upon deployment to the serving hub device.

9. The serving hub device of claim 8, wherein the model searching procedure uses at least one of a named entity recognition process or a syntactical and semantic matching process.

10. The serving hub device of claim 1, wherein the operations further comprise performing a global training procedure in which the machine learning model is trained on global data that is collected from at least one of: multiple different service management and orchestration devices or multiple different radio access network intelligent controllers.

11. The serving hub device of claim 1, wherein the operations further comprise performing a global sharing procedure in which a pre-trained machine learning model that is trained on global data or local data is shared by the service management and orchestration device to another service management and orchestration device.

12. A non-transitory computer-readable medium comprising instructions that, in response to execution, cause a serving hub, of a near real time radio access network intelligent controller, comprising a processor to perform operations, comprising:
determining that the near-real time radio access network intelligent controller has received, from a service management and orchestration device, first authentication data representative of a first authentication to deploy an xApp on the near-real time radio access network intelligent controller;
receiving, from the service management and orchestration device, authentication to deploy, on the serving hub, a machine learning model that is communicatively coupled to the xApp; and
communicating, according to an authentication protocol, via a group of application programming interfaces, comprising at least a predict application programming interface in which the machine learning model receives a request from the xApp and, in response, provides a prediction to the xApp to satisfy the request.

13. The non-transitory computer-readable medium of claim 12, wherein the group of application programming interfaces further comprises at least one of:
a deploy application programming interface that facilitates authenticated deployment, to the serving hub, of the machine learning model that was pre-trained by the model manager device according to a first dataset;
a retrain application programming interface that retrains all model weights of the machine learning model based on a received second dataset, resulting in a retrained machine learning model, and calls the deploy application programming interface to deploy the retrained machine learning model on the serving hub; or
a fine tune application that tunes at least model weight of the machine learning model based on a received third dataset, resulting in a tuned machine learning model, and calls the deploy application programming interface to deploy the tuned machine learning model on the serving hub.

14. The non-transitory computer-readable medium of claim 13, further comprising a a model manager device that manages the machine learning model, wherein the model manager device is situated in the near real time radio access network intelligent controller and uses resources of the near real time radio access network intelligent controller to process all calls to the group of application programming interfaces.

15. The non-transitory computer-readable medium of claim 13, further comprising a model manager device that manages the machine learning model, wherein the model manager device is situated in the service management and orchestration device and uses resources of the service management and orchestration device to process a group of calls to the group of application programming interfaces.

16. The non-transitory computer-readable medium of claim 15, wherein the model manager device exposes the predict application programming interface in the serving hub and uses resources of the near real time radio access network intelligent controller to process calls to the predict application.

17. A method, comprising:
determining, by a device comprising a processor, that the near-real time radio access network intelligent controller has received, from a service management and orchestration device, first authentication data representative of a first authentication to deploy an xApp on the near-real time radio access network intelligent controller;
receiving, by the device, second authentication data representative of a second authentication to deploy a machine learning model on a serving hub of the near-real time radio access network intelligent controller, wherein the second authentication is received from the service management and orchestration device; and
facilitating, by the device, authenticated communication for a model manager device that manages the machine learning model via a group of application programming interfaces, comprising at least a predict application programming interface in which the machine learning model receives a request from the xApp and, in response, provides a prediction to the xApp to satisfy the request.

18. The method of claim 17, further comprising performing, by the device, a caching procedure that determines, from among a group of machine learning models that is deployed on the serving hub, a subscribed group of machine learning models that is to be placed in a cache.

19. The method of claim 17, further comprising performing, by the device, a model searching procedure that, in response to a search query, determines, from among a group of machine learning models that is deployed on the serving hub, a most relevant group of machine learning models that satisfies the search query and provides documentation associated with the most relevant group of machine learning models.

20. The method of claim 17, further comprising performing, by the device, a global training procedure in which the machine learning model is trained on global data that is collected from at least one of: multiple different service management and orchestration devices or multiple different radio access network intelligent controllers.
